(19) United States
(12) Patent Application Publication
(10) Pub. No.: US 2026/0053175 A1
(43) Pub. Date: Feb. 26, 2026

(54) Method for producing water-redispersible food preparations in dry form

(71) Applicant: DMK Deutsches Milchkontor GmbH, Zeven (DE)

(72) Inventor: Nils HILKER, Hamburg (DE)

(21) Appl. No.: 19/244,641

(22) Filed: Jun. 20, 2025

(30) Foreign Application Priority Data
Jun. 25, 2024 (DE) 24184226.9

(51) Int. Cl. A23L 5/10; A23B 2/90; A23L 19/00; A23L 33/00

(52) U.S. Cl. CPC A23L 5/10; A23B 2/90; A23L 19/01; A23L 19/09; A23L 33/40

(57) ABSTRACT

A method is proposed for the production of water-redispersible food preparations in dry form. The method involves providing an aqueous food preparation; gently heating the preparation from step (a) to temperatures in the range of about 50 to about 100° C. for a period of about 1 to about 30 minutes; gently drying the preparation from step (b) at temperatures in the range of about 50 to about 80° C.; providing a water-impermeable lightweight packaging; filling the dried preparation from step (c) into the plastic packaging from step (d); and sealing the filled packaging.

### AREA OF THE INVENTION

The present relates to the field of packaging and concerns a method for providing an improved dosage form for food, in particular for infant nutrition.

### TECHNOLOGICAL BACKGROUND

Currently, ready-made meals for infant nutrition are mainly offered in heavy glass packaging. This form of presentation is not very sustainable, as the jars rarely end up in the glass recycling bin but are ultimately disposed of. The high transport weight worsens the CO₂ balance for trade and industry and literally makes shopping heavier for the buyer. Furthermore, there is a risk of glass breakage during handling and thus also a risk of glass splinters in the food. When such glass packaging is heated, it also heats up as a whole, making it difficult to remove from a microwave, for example.

The manufacture of such products is also not without problems. For example, vegetable and fruit preparations must be subjected to high-temperature treatment and preserved, which causes the products to lose texture, taste, and important ingredients, such as vitamins. Since there can be a long period of time between the manufacture, delivery, purchase, and consumption of the products, the preparations must have a sufficient shelf life. However, many consumers do not want the preservatives that are necessary for this.

### STATE OF THE ART

The prior art discloses tubular bags (“pouches”) as packaging for, for example, detergents, cat food, tobacco, and liquid foods:

WO 1999 064308 A1 (IDEA PACK) relates to a resealable bag with a front and a back, the side edges of which are sealed together. The back side protrudes beyond the front side to form a closure flap and, together with an upper edge of the front side, forms a bag opening which is sealed by a sealing edge during the manufacture or filling of the bag. A tear-open seam is provided which can be torn open when the bag is opened for the first time and forms an access opening when torn open. The closure flap can be folded over the upper edge of the front so that it covers this opening and can be reversibly fixed in this position. The sealing seam and the tear-open seam are embodied together by a closing seam which extends below the upper edge of the front side at a distance therefrom. The front side forms a tear-open flap between the closing seam and the upper edge, which together with the closing flap forms a gripping means for tearing open the closing edge.

EP 2050689 A1 (HUHTAMAKI) claims a bag with a layer provided with a perforation line running between two boundary areas, the line being located in the upper half, preferably in two-thirds to three-quarters of the height of the bag. The end points of the line are provided with a weld seam, and a carrying handle is arranged above the line. A plastic film web is folded in the handle area and the side edges of the web are welded together and led away from a fold. The line is arranged parallel to the fold and is limited by welding the edges.

DE19951357 A1 (HENKEL) discloses a package consisting of a tubular bag made of a flexible material with flat ends when filled, which are formed from at least two flat bag side sections lying on top of each other, which are connected to each other by a sealing seam running essentially transversely to the bag transverse axis and have an inwardly directed perforation line in the flat bag end.

### SUMMARY

Therefore, the task of the present invention was to provide food, especially for infant nutrition, in such a form that the disadvantages of the prior art described above are avoided. The products should be lightweight, sustainable in terms of production and packaging, retain the full quality of the raw materials, and have a shelf life of at least four weeks without the addition of preservatives.

An object of the invention relates to a process for the production of water-redispersible food preparations in dry form, comprising or consisting of the following steps:
(a) providing an aqueous food preparation;
(b) gently heating the preparation from step (a) to temperatures in the range of about 50 to about 100° C. over a period of about 1 to about 30 minutes;
(c) gently drying the preparation from step (b) at temperatures in the range of about 5 to about 50° C.;
(d) providing a water-impermeable lightweight packaging;
(e) filling the dried preparation from step (c) into the lightweight packaging from step (d); and
(f) sealing the filled packaging from step (e).

The method according to the invention comprises three essential features, namely gentle heating to a maximum of 100° C., equally gentle dehydration at a maximum of 50° C., and filling the dried product into lightweight packaging that protects the product from moisture and is preferably made of plastic, in particular a sachet or a pouch bag. The process does not require high-temperature heating, as the water and thus the basis for germ growth is subsequently removed from the product. In this way, the texture, taste, and ingredients of the original preparation are retained: vegetable and fruit pieces remain firm and do not disintegrate, and vitamins are not destroyed. Drying also takes place under mild conditions, preferably by condensation drying, which means that both the water is completely removed and the components of the preparation are not affected. At the same time, the shelf life of the products is improved in the desired manner so that the addition of preservatives is no longer necessary. The use of sachets or, in particular, pouch bags as packaging also avoids the problems associated with glass packaging, i.e., environmental impact, weight when shopping, and the risk of breakage. In addition, recyclable packaging material can be used. Thus, by combining various steps known per se, the method according to the invention provides a product in packaging that together fully meets the complex requirements profile.

To prepare a meal using the food preparation method, the contents only need to be redispersed in water and heated.

### Food

In a preferred embodiment of the present invention, the foodstuffs are semi-liquid to pasty, specially mashed foods, such as those used for feeding infants. These may contain pieces of vegetables or fruit, which give the preparation the desired texture and taste. Preferably, therefore, these are baby porridges or ready-made meals for infants or people who are dependent on foods of this type.

### Gentle Heating

Gentle heating, in contrast to the usual high-temperature treatment, means that the food preparations are heated to approximately 50 to approximately 100° C. for approximately 1 to approximately 30 minutes. Preferably, the treatment takes place for about 10 to about 15 minutes at a temperature of about 70 to about 80° C. These conditions are sufficient to cook the “raw” ingredients without losing texture, taste, and nutrients. A higher temperature—for example, in the sense of pasteurization—as known from the prior art is not necessary, since the water and thus the breeding ground for germs is removed from the preparations in the following step.

### Gentle Drying

Gentle drying, in contrast to the usual spray drying, which takes place at temperatures around 180° C., means that the previously heated food preparations are dried at temperatures in the range of about 5 to about 50° C., and in particular about 10 to about 30° C. The process step can be designed as condensation drying, contact drying, freeze drying, fluidized bed drying, dielectric drying, or a combination of such processes.

Condensation drying, as known from laundry drying, is particularly preferred. For this purpose, moist air is passed by means of fans over cooling fins or cooling lamellas whose temperature is below the dew point of the air. The water condenses and collects as condensation on the cold surface, which is collected in a separate container. The cooled and dehumidified air is then heated and discharged as dry air. The preferred temperature range here is approximately 5 to approximately 30° C., whereby the moisture content of the product to be dried can be between 40 and 99%. As a rule, the preparations are dried to a water content of less than 5% by weight, preferably from approximately 0.5 to approximately 1% by weight.

### Sachets

The dried products are dry powders that may still contain pieces of vegetables or fruit, also in dehydrated form. The products are then filled into plastic packaging and sealed. In a first embodiment of the invention, these may be sachets. These are plastic bags made of a water-soluble and food-grade polymer, such as PVP. The bags are dissolved in a defined amount of water and release their contents.

### Pouch Bags

In a second and preferred embodiment, the dried preparations are filled into tube or pouch bags. These are generally used to package liquid products. Such products can be foodstuffs, beverages, liquid detergents, and the like. It is particularly important that these be hermetically sealed in all cases. Pouch bags consist of two side wall blanks that are firmly connected to a bottom blank by means of weld seams. The weld seam connecting the bottom panel to each side panel has a semicircular or semi-elliptical shape on the flat bottom. The longitudinal weld seams run across the bottom panel of the finished pouch bag, fixing the bottom fold formed by the bottom between the side wall sections. At the same time, an edge is formed which allows the pouch bag to stand upright when filled.

To produce the empty pouch bags, the two side wall blanks are placed on top of each other. The folded bottom blank is inserted between the two side wall blanks. The stack thus formed is thermally welded, with all weld seams being produced simultaneously, with the exception of the last weld seam, which closes the bag and is applied after filling. The film used is preferably multi-layered and consists of a material that facilitates residue-free removal and is suitable for use with food. The temperature gradient across the film thickness is used to determine where welding occurs. This ensures, in particular, that the bottom fold can reopen in the bottom area after the pouch bag has been produced in order to create the standing surface and increase the filling volume. In the upper area, the bags usually have one or two opposite notches to facilitate tearing open the bag.

In a preferred embodiment, the preparations are characterized in that an upper and a lower corner located on the same side of the pouch bag are designed as grip surfaces. In a further preferred embodiment, the preparations are characterized in that the pouch bag has a device at its lower end with which it can be rolled up for complete removal. It is also possible to make the pouch resealable. The pouches are usually filled with 50 to 95% of their volume with food, preferably 80 to 95%.

### EXAMPLES

### Comparative Example C1

10 kg of carrots and 5 kg of floury potatoes were cut into small pieces and boiled in 10 L of water for about 15 minutes. 1 kg of cereal flakes were added and boiled for another 5 minutes. The mixture was then cooled, mixed with 200 mL of rapeseed oil and 500 ml of orange juice, and homogenized. The paste-like mixture was then spray-dried at a head temperature of 180° C. in a pilot plant and the dry powder, which still had a residual moisture content of 2% by weight, was filled into tubular bags. These were then stored at 20° C. for 2 weeks and then redispersed in water. The product was then tasted by five experienced food chemists. The product was unanimously rated as bland with a rancid undertone.

### Comparative Example C2

Comparative example C1 was repeated, but 25 g of the preservative potassium sorbate was added after homogenization. After storage and the addition of water, the product was described as bland in taste, but was free of a rancid undertone.

### Example 1

Comparative example C1 was repeated, but the preparation was only cooked for 10 minutes at 75° C. The product was then homogenized, with pieces of vegetable still visible in the pulp. This was followed by condensation drying at 10° C. and filling into tubular bags. This batch was also stored at 20° C. for 2 weeks and then redispersed in water. The product was then tasted by 5 experienced food chemists. The product was unanimously rated as fresh with no rancid undertone.

The tests show that preparations that are heated to high temperatures and then dried at high temperatures also have a bland taste after redispersion in water. The texture is uniform, i.e., there are no pieces of vegetables or fruit in it. Without the addition of preservatives, the products also have a rancid aftertaste.

In contrast, the process according to the invention leads to a product with the desired texture, in which pieces of vegetables and fruit are still present and which still has a fresh taste even after prolonged storage, even without the addition of preservatives.

What claimed is:

1. A method for the production of water-redispersible food preparations in dry form, comprising or consisting of the following steps:
(a) providing an aqueous food preparation;
(b) gently heating the preparation from step (a) to temperatures in the range of about 50 to about 100° C. for a period of about 1 to about 30 minutes;
(c) gently drying the preparation from step (b) at temperatures in the range of about 5 to about 50° C.;
(d) providing a water-impermeable lightweight packaging;
(e) filling the dried preparation from step (c) into the lightweight packaging from step (d); and
(f) sealing the filled packaging from step (e).

2. The method according to claim 1, wherein the food preparations containing vegetables and/or fruits are used.

3. The method according to claim 1, wherein the food preparations in liquid or paste form are used.

4. The method according to claim 1, wherein the food preparations are used which still contain pieces of vegetables and/or fruits.

5. The method according to claim 1, wherein the food preparations are used which are baby food or meals for small children and people who are dependent on food of this type.

6. The method according to claim 1, wherein the food preparations from step (a) are heated at a temperature in the range of about 70 to about 80° C. for a period of about 10 to about 15 minutes.

7. The method according to claim 1, wherein the heated preparations from step (a) are subjected to gentle drying at a temperature in the range of about 10 to about 30° C.

8. The method according to claim 1, wherein the gentle drying is carried out as condensation drying, contact drying, freeze drying, fluidized bed drying, or dielectric drying, or as a combination of such methods.

9. The method according to claim 1, wherein the heated preparations from step (a) are dried to a maximum residual water content of 5% by weight.

10. The method according to claim 1, wherein the heated preparations from step (a) are dried to a residual water content of 0.5 to 1% by weight.

11. The method according to claim 1, wherein the dried preparations from step (c) are filled into a sachet or a pouch bag.

12. The method according to claim 1, wherein the pouch bags are designed to be resealable.
